(19) United States
(12) Patent Application Publication
(10) Pub. No.: US 2016/0103330 A1
(43) Pub. Date: Apr. 14, 2016

(54) SYSTEM AND METHOD FOR ADJUSTING PARALLAX IN THREE-DIMENSIONAL STEREOSCOPIC IMAGE REPRESENTATION

(71) Applicant: 3doo, Inc., New York, NY (US)

(72) Inventor: Ingo Nadler, Bad Breisig (DE)

(73) Assignee: 3doo, Inc., New York, NY (US)

(21) Appl. No.: 14/511,478

(22) Filed: Oct. 10, 2014

(51) Int. Cl. G02B 27/22; H04N 19/40

(52) U.S. Cl. CPC G02B 27/2214; H04N 19/40

(57) ABSTRACT

A method for adjusting parallax in three-dimensional stereoscopic image representation is presented, the method including taking a plurality of shots, performing disparity analysis for each of the plurality of shots, assigning a minimum parallax value and a maximum parallax value at a beginning and an end of each shot of the plurality of shots, adjusting a predetermined number of frames of each shot of the plurality of shots to move parallax into comfort zone, and transcoding video to a plurality of screen sizes for distribution.

### BACKGROUND

1. Technical Field

The present disclosure relates to stereoscopic image representation. More particularly, the present disclosure relates to a system and method for adjusting parallax in three-dimensional stereoscopic image representation.

2. Description of Related Art

Three dimensional views are created because each eye sees the world from a slightly different vantage point. Distance to objects is then perceived by the depth perception process which combines the signals from each eye. Depth perception is simulated by computer displays and projection systems.

Stereoscopic representation involves presenting information for different pictures, one for each eye. The result is the presentation of at least two stereoscopic pictures, one for the left eye and one for the right eye. Stereoscopic representation systems often work with additional accessories for the user, such as active or passive 3D eyeglasses. Auto-stereoscopic presentation is also possible, which functions without active or passive 3D eyeglasses.

Passive polarized eyeglasses are commonly used due to their low cost of manufacture. Polarized eyeglasses use orthogonal or circular polarizing filters to extinguish right or left handed light from each eye, thus presenting only one image to each eye. Use of a circular polarizing filter allows the viewer some freedom to tilt their head during viewing without disrupting the 3D effect.

Active eyeglasses such as Shutter eyeglasses are commonly used due to their low cost of manufacture. Shutter eyeglasses consist of a liquid crystal blocker in front of each eye which serves to block or pass light through in synchronization with the images on the computer display, using the concept of alternate-frame sequencing.

Stereoscopic pictures, which yield a stereo pair, are provided in a fast sequence alternating between left and right, and then switched to a black picture to block the particular eye's view. In the same rhythm, the picture is changed on the output display device (e.g., screen or monitor). Due to the fast picture changes (often at least 25 times a second), the observer has the impression that the representation is simultaneous and this leads to the creation of a stereoscopic 3D effect.

Moreover, the principles of stereoscopic 3D cinematography are known, but recently it became very popular and the demand for devices being able to display stereoscopic 3D content is increasing rapidly. In particular, the entertainment industry has begun to develop television devices with a stereoscopic 3D capability. However, a principle problem with the display of stereoscopic 3D content is the often occurring discrepancy between shooting condition and viewing condition related to the depth impression perceived by the viewer. Factors for the depth impression are the display screen size of the television set, the distance and position of the viewer in front of the display, and the individual interocular (eye) distance.

The display of 3D content can therefore present problems for the viewer. Common problems can be the experience of eye divergence when looking at a far point of the scene, or the confusing impression between eye vergence and eye accommodation when fixating an object with too high apparent distance from the display screen.

The “comfort zone” defines an area before and behind the screen or display plane of a TV set in which the fixating of an object could be done by the viewer without any eye vergence and eye accommodation problems. In other words, the comfort zone describes the depth relative to the display screen which should be used for displaying objects.

This comfort zone, which defines a depth range around the screen or display plane, is closely related to the disparity between left and right views. A method to change the perceived depth for the viewer is therefore to change the disparity between left and right images. In the simplest form, this can be achieved by a horizontal scale and shift operation of left and right images when presented on the display. The scale operation applied equally to both images will scale the disparity range by the same amount. The horizontal shift of left versus right images will reposition the plane of zero disparity, i.e., a specific depth plane in the scene can be positioned in the plane of the display screen in order to adjust the scene depth within the comfort zone of the display.

In other words, one of issue with displaying 3D content is to bring the depth range used in the delivered stereoscopic 3D content into the comfort zone of the display device, for example a television set. This is achieved by scaling the depth range such that the maximum depth range of the delivered content substantially corresponds to the depth range of the comfort zone. Further, the depth range of the delivered content may also be shifted relative to the display screen plane.

What is needed is a method and system capable of converting current simulator software or simulator software output to provide stereoscopic 3D displays, which is easy to implement across a variety of application software, does not require rewriting of each existing software platform, and presents a high quality user experience.

### SUMMARY

Embodiments of the present disclosure are described in detail with reference to the drawing figures wherein like reference numerals identify similar or identical elements.

An aspect of the present disclosure provides a method for adjusting parallax in three-dimensional stereoscopic image representation, the method including capturing a plurality of shots to create a 3D video, transmitting the plurality of shots, via a network, to a disparity analysis module, performing disparity analysis for each of the plurality of shots, assigning a minimum parallax value and a maximum parallax value at a beginning and an end of each shot of the plurality of shots, adjusting a predetermined number of frames of each shot of the plurality of shots to move parallax into a comfort zone, and transcoding the 3D video to a plurality of screen sizes for distribution.

Another aspect of the present disclosure provides displaying the plurality of shots on display hardware.

In one aspect, the display hardware is a 3D cave. Alternatively, the display hardware is one or more power walls. Alternatively, the display hardware is one or more wearable stereoscopic display devices.

In another aspect, the predetermined number of frames is ten. Alternatively, the predetermined number of frames is the last ten frames of each shot of the plurality of shots.

In yet another aspect, the adjusting step includes shifting left and right perspective views of each of the plurality of shots to smooth out jumps in the parallax.

Another aspect of the present disclosure provides a system for adjusting parallax in three-dimensional stereoscopic image representation, the system including a network having one or more communication channels, a plurality of image capturing devices for capturing a plurality of shots, and a disparity analysis module for performing disparity analysis for each of the plurality of shots received via the network. The system further includes a parallax threshold calculator for at least assigning a minimum parallax value and a maximum parallax value at a beginning and an end of each shot of the plurality of shots, a stereoscopic image adjuster for adjusting a predetermined number of frames of each shot of the plurality of shots to move parallax into comfort zone, and a stereoscopic output module for transcoding video to a plurality of screen sizes for distribution.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

### BRIEF DESCRIPTION OF THE DRAWING

Various embodiments of the present disclosure are described herein below with references to the drawings, wherein:

FIG. 1 is a flowchart depicting a process for adjusting parallax in three-dimensional stereoscopic image representation, in accordance with embodiments of the present disclosure; and

FIG. 2 is a system for adjusting parallax in three-dimensional stereoscopic image representation, in accordance with embodiments of the present disclosure.

The figures depict embodiments of the present disclosure for purposes of illustration only. One skilled in the art will readily recognize from the following disclosure that alternative embodiments of the structures and methods illustrated herein may be employed without departing from the principles of the present disclosure described herein.

### DETAILED DESCRIPTION

Although the present disclosure will be described in terms of specific embodiments, it will be readily apparent to those skilled in this art that various modifications, rearrangements and substitutions may be made without departing from the spirit of the present disclosure. The scope of the present disclosure is defined by the claims appended hereto.

For the purposes of promoting an understanding of the principles of the present disclosure, reference will now be made to the exemplary embodiments illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

Stereoscopic view refers to a perceived image that appears to encompass a 3-dimensional (3D) volume. To generate the stereoscopic view, a device displays two images on a 2-dimensional (2D) area of a display. These two images include substantially similar content, but with slight displacement along the horizontal axis of one or more corresponding pixels in the two images. The simultaneous viewing of these two images, on a 2D area, causes a viewer to perceive an image that is popped out of or pushed into the 2D display that is displaying the two images. In this way, although the two images are displayed on the 2D area of the display, the viewer perceives an image that appears to encompass the 3D volume.

The two images of the stereoscopic view are referred to as a left-eye image and a right-eye image, respectively. The left-eye image is viewable by the left eye of the viewer, and the right-eye image is not viewable by the left eye of the viewer. Similarly, the right-eye image is viewable by the right eye of the viewer, and the left-eye image is not viewable by the right eye of the viewer. For example, the viewer may wear specialized glasses, where the left lens of the glasses blocks the right-eye image and passes the left-eye image, and the right lens of the glasses blocks the left-eye image and passes the right-eye image.

Because the left-eye and right-eye images include substantially similar content with slight displacement along the horizontal axis, but are not simultaneously viewable by both eyes of the viewer (e.g., because of the specialized glasses), the brain of the viewer resolves the slight displacement between corresponding pixels by commingling the two images. The commingling causes the viewer to perceive the two images as an image with 3D volume.

Three-dimensional (3D) cameras, such as stereo cameras or multi-view cameras, generally capture left and right images using two or more cameras functioning similarly to human eyes, and cause a viewer to feel a stereoscopic effect due to disparities between the two images. Specifically, a user observes parallax due to the disparity between the two images captured by a 3D camera, and this binocular parallax causes the user to experience a stereoscopic effect.

When a user views a 3D image, the binocular parallax which the user sees can be divided into (a) negative parallax, (b) positive parallax, and (c) zero parallax. Negative parallax means objects appear to project from a screen, and positive parallax means objects appear to be behind the screen. Zero parallax refers to the situation where objects appear to be on the same horizontal plane as the screen.

In 3D images, negative parallax generally has a greater stereoscopic effect than positive parallax, but has a greater convergence angle than positive parallax, so viewing positive parallax is more comforting to the human eyes. However, if objects in 3D images have only positive parallax, eyes feel fatigue even though eyes feel comfortable in the positive parallax. In the same manner, if objects in 3D images have only negative parallax, both eyes feel fatigue.

Parallax refers to the separation of the left and right images on the display screen. Motion parallax refers to objects moving relative to each other when one's head moves. When an observer moves, the apparent relative motion of several stationary objects against a background gives hints about their relative distance. If information about the direction and velocity of movement is known, motion parallax can provide absolute depth information.

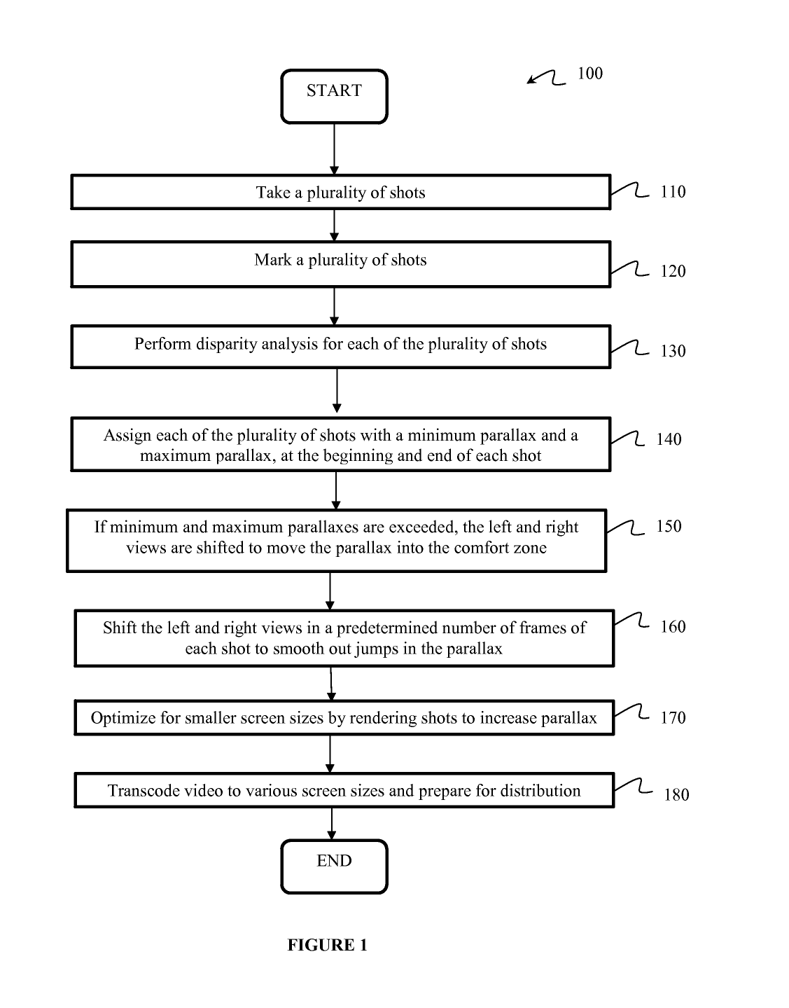

FIG. 1 is a flowchart depicting a process for adjusting parallax in three-dimensional stereoscopic image representation, in accordance with embodiments of the present disclosure.

The flowchart 100 includes the following steps. In step 110, a plurality of shots are taken. In step 120, the plurality of shots are marked. In step 130, disparity analysis is performed for each of the plurality of shots. In step 140, each of the plurality of shots is assigned with a minimum parallax and a maximum parallax, at the beginning and at the end of each shot of the plurality of shots. In step 150, if the minimum and maximum parallaxes are exceeded, then the left and right views are shifted to move the parallax into the comfort zone. In step 160, the left and right views are shifted in a predetermined number of frames of each shot to smooth out the jumps in the parallax. In step 170, the shots are optimized for smaller screen sizes. In step 180, the video is transcoded to various screen sizes and prepared for distribution. The process then ends. It is to be understood that the method steps described herein need not necessarily be performed in the order as described. Further, words such as “thereafter,” “then,” “next,” etc., are not intended to limit the order of the steps. These words are simply used to guide the reader through the description of the method steps.

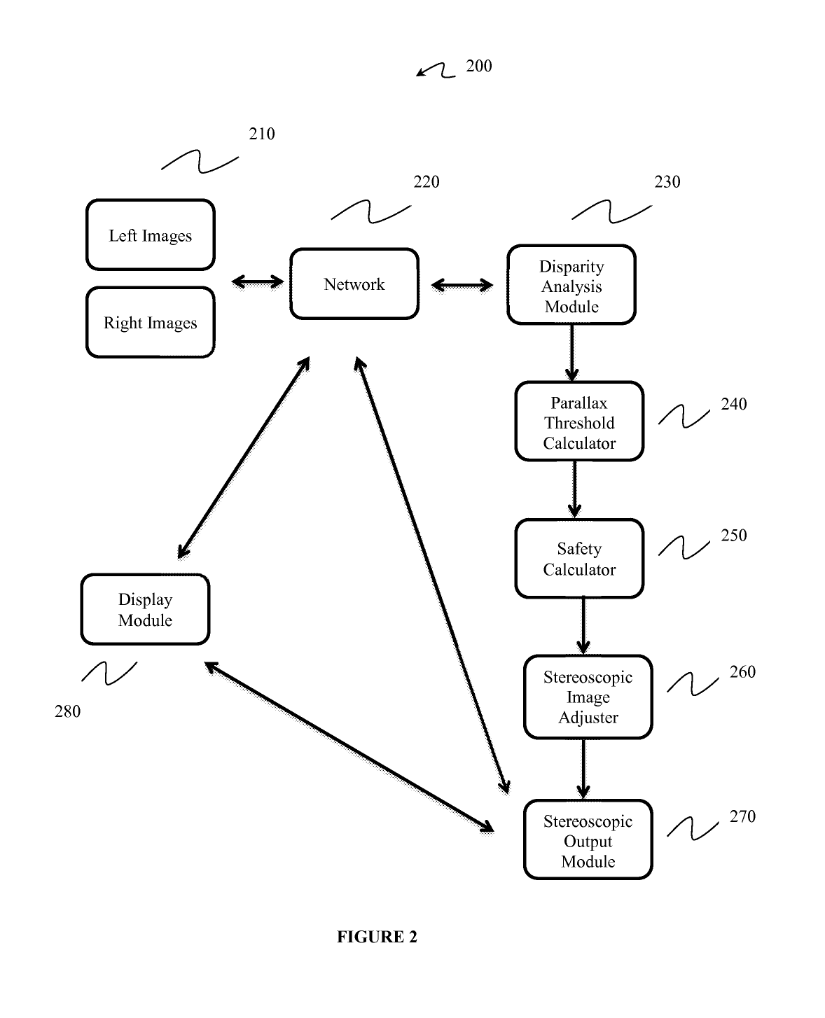

FIG. 2 is a system for adjusting parallax in three-dimensional stereoscopic image representation, in accordance with embodiments of the present disclosure.

System 200 includes a generating means for generating left and right images 210. The left and right images 210 are sent, via a network 220, to a disparity analysis module 230. Subsequently, after disparity analysis has taken place, the data/information is sent to a parallax threshold calculator 240, a safety calculator 250, and a stereoscopic image adjuster 260. The data/information is then sent to the stereoscopic output module 270 that electrically cooperates with a display module 280 for displaying the data/information in 3D.

The parallax threshold calculator 240 takes the input (i.e., the plurality of captured shots) and determines the minimum and maximum allowable parallax for the content (i.e., for each of the plurality of captured shots). In an alternative embodiment, the parallax threshold calculator 240 determines minimum and maximum values allowable for disparity or depth, rather than parallax.

The safety calculator 250 compares the predetermined threshold values to the actual content peaking values and determines whether action is required or not. For example, the safety calculator 250 may be a comparator, triggered when the assigned min and max values of the parallax exceed one or more predetermined thresholds. An action to be taken if the min and/or max values are exceeded for one or more shots is to shift the left and right view of the shots to move the parallax into the comfort zone. The left and right views are shifted in a predetermined number of frames of each shot to smooth out jumps in the parallax. For example, the predetermined number of frames may be 10 frames. Alternatively, the predetermined number of frames may be the last ten frames of each shot of the plurality of shots. One skilled in the art may contemplate using any number of frames or any number of last frames of each shot of a plurality of shots to adjust the parallax.

The display module 280 may be one or more 3D caves and/or one or more power walls and/or one or more wearable stereoscopic display devices. One skilled in the art may contemplate any number of different 3D display mechanisms, whether wearable or not, to display the 3D video.

Network 220 may be a group of interconnected (via cable and/or wireless) computers, databases, servers, routers, and/or peripherals that are capable of sharing software and hardware resources between many users. The Internet is a global network of networks. Network 220 may be a communications network. Thus, network 220 may be a system that enables users of data communications lines to exchange information over long distances by connecting with each other through a system of routers, servers, switches, databases, and the like.

Network 220 may include a plurality of communication channels. The communication channels refer either to a physical transmission medium such as a wire or to a logical connection over a multiplexed medium, such as a radio channel. A channel is used to convey an information signal, for example a digital bit stream, from one or several senders (or transmitters) to one or several receivers. A channel has a certain capacity for transmitting information, often measured by its bandwidth. Communicating data from one location to another requires some form of pathway or medium. These pathways, called communication channels, use two types of media: cable (twisted-pair wire, cable, and fiber-optic cable) and broadcast (microwave, satellite, radio, and infrared). Cable or wire line media use physical wires of cables to transmit data and information. The communication channels are part of network 220.

Therefore, in summary, a plurality of shots are taken and each of the shots is marked or assigned with a minimum and maximum parallax. If at least one of the minimum or maximum parallaxes' are exceeded for a shot, the left and right views are shifted in order to move the parallax into the comfort zone. Depth cuts are then introduced to smooth out jumps in the parallax and the shots are optimized for smaller screens. The shots are then transcoded to various screen sizes and prepared for distribution to 3D display devices. Therefore, the embodiments of the present disclosure introduce a shot-based 3D analysis and pre-processing stage before the 3D video is re-formatted and transcoded to match various screen resolutions. During the pre-processing stage, the 3D effect (or parallaxes) are adjusted or altered to accommodate for various screen resolutions during distribution of the 3D video.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, tablets, portable/personal digital assistants, and other devices that facilitate communication of information between end-users within a network.

The general features and aspects of the present disclosure remain generally consistent regardless of the particular purpose. Further, the features and aspects of the present disclosure may be implemented in system in any suitable fashion, e.g., via the hardware and software configuration of system or using any other suitable software, firmware, and/or hardware.

For instance, when implemented via executable instructions, various elements of the present disclosure are in essence the code defining the operations of such various elements. The executable instructions or code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media may include any medium that may store or transfer information.

The computer means or computing means or processing means may be operatively associated with the stereoscopic system, and is directed by software to compare the first output signal with a first control image and the second output signal with a second control image. The software further directs the computer to produce diagnostic output. Further, a means for transmitting the diagnostic output to an operator of the verification device is included. Thus, many applications of the present disclosure could be formulated. The exemplary network disclosed herein may include any system for exchanging data or transacting business, such as the Internet, an intranet, an extranet, WAN (wide area network), LAN (local area network), satellite communications, and/or the like. It is noted that the network may be implemented as other types of networks.

Additionally, “code” as used herein, or “program” as used herein, may be any plurality of binary values or any executable, interpreted or compiled code which may be used by a computer or execution device to perform a task. This code or program may be written in any one of several known computer languages. A “computer,” as used herein, may mean any device which stores, processes, routes, manipulates, or performs like operation on data. A “computer” may be incorporated within one or more transponder recognition and collection systems or servers to operate one or more processors to run the transponder recognition algorithms. Moreover, computer-executable instructions include, for example, instructions and data which cause a general purpose computer, special purpose computer, or special purpose processing device to perform a certain function or group of functions. Computer-executable instructions also include program modules that may be executed by computers in stand-alone or network environments. Generally, program modules include routines, programs, objects, components, and data structures, etc., that perform particular tasks or implement particular abstract data types.

Persons skilled in the art will understand that the devices and methods specifically described herein and illustrated in the accompanying drawings are non-limiting exemplary embodiments. The features illustrated or described in connection with one exemplary embodiment may be combined with the features of other embodiments. Such modifications and variations are intended to be included within the scope of the present disclosure.

The foregoing examples illustrate various aspects of the present disclosure and practice of the methods of the present disclosure. The examples are not intended to provide an exhaustive description of the many different embodiments of the present disclosure. Thus, although the foregoing present disclosure has been described in some detail by way of illustration and example for purposes of clarity and understanding, those of ordinary skill in the art will realize readily that many changes and modifications may be made thereto without departing form the spirit or scope of the present disclosure.

While several embodiments of the disclosure have been shown in the drawings and described in detail hereinabove, it is not intended that the disclosure be limited thereto, as it is intended that the disclosure be as broad in scope as the art will allow. Therefore, the above description and appended drawings should not be construed as limiting, but merely as exemplifications of particular embodiments. Those skilled in the art will envision other modifications within the scope and spirit of the claims appended hereto.

What is claimed is:

1. A method for adjusting parallax in three-dimensional stereoscopic image representation, the method comprising:
capturing a plurality of shots to create a 3D video;
transmitting the plurality of shots, via a network, to a disparity analysis module;
performing disparity analysis for each of the plurality of shots;
assigning a minimum parallax value and a maximum parallax value at a beginning and an end of each shot of the plurality of shots;
adjusting a predetermined number of frames of each shot of the plurality of shots to move parallax into a comfort zone; and
transcoding the 3D video to a plurality of screen sizes for distribution.

2. The method of claim 1, further comprising displaying the plurality of shots on display hardware.

3. The method of claim 2, wherein the display hardware is a 3D cave.

4. The method of claim 2, wherein the display hardware is one or more power walls.

5. The method of claim 2, wherein the display hardware is one or more wearable stereoscopic display devices.

6. The method of claim 1, wherein the predetermined number of frames is ten.

7. The method of claim 1, wherein the predetermined number of frames is the last ten frames of each shot of the plurality of shots.

8. The method of claim 1, wherein each of the plurality of shots includes a left perspective view and a right perspective view.

9. The method of claim 1, wherein the adjusting step includes shifting left and right perspective views of each of the plurality of shots to smooth out jumps in the parallax.

10. A system for adjusting parallax in three-dimensional stereoscopic image representation, the system comprising:
a network having one or more communication channels;
a plurality of image capturing devices for capturing a plurality of shots;
a disparity analysis module for performing disparity analysis for each of the plurality of shots received via the network;
a parallax threshold calculator for at least assigning a minimum parallax value and a maximum parallax value at a beginning and an end of each shot of the plurality of shots;
a stereoscopic image adjuster for adjusting a predetermined number of frames of each shot of the plurality of shots to move parallax into comfort zone; and
a stereoscopic output module for transcoding video to a plurality of screen sizes for distribution.

11. The system of claim 10, further comprising displaying the plurality of shots on display module.

12. The system of claim 11, wherein the display module is a 3D cave.

13. The system of claim 11, wherein the display module is one or more power walls.

14. The system of claim 11, wherein the display module is one or more wearable stereoscopic display devices.

15. The system of claim 10, wherein the predetermined number of frames is ten.

16. The system of claim 10, wherein the predetermined number of frames is the last ten frames of each shot of the plurality of shots.

17. The system of claim 10, wherein each of the plurality of shots includes a left perspective view and a right perspective view.

18. The system of claim 10, wherein the stereoscopic image adjuster further includes shifting left and right perspective views to smooth out jumps in the parallax.
